(19) United States
(12) Patent Application Publication
(10) Pub. No.: US 2017/0178511 A1
(43) Pub. Date: Jun. 22, 2017

(54) DETERMINING PARKING STATUS AND PARKING AVAILABILITY

(71) Applicants: Landon Berns, New York, NY (US); Alexander Glasser, New York, NY (US)

(72) Inventors: Landon Berns, New York, NY (US); Alexander Glasser, New York, NY (US)

(21) Appl. No.: 15/125,347

(22) PCT Filed: Mar. 18, 2015
(86) PCT No.: PCT/US15/21349

§ 371 Date: Sep. 12, 2016

Related U.S. Application Data
(60) Provisional application No. 62/054,444, filed on Sep. 24, 2014.
(60) Provisional application No. 61/955,160, filed on Mar. 18, 2014.

(51) Int. Cl. G08G 1/14; H04W 4/02; H04B 1/3822

(52) U.S. Cl. CPC G08G 1/143; H04B 1/3822; H04W 4/025

(57) ABSTRACT

Systems and methods are disclosed for determining parking status and parking availability. In one implementation, a processing device receives one or more first inputs from a first device, processes the inputs to compute a first chronological interval with respect to which a first vehicle is likely to leave a parking location, receives parking request(s) from various devices, each of the requests including a current location and a destination, processes the parking requests to compute, in relation to the parking location, a degree of compatibility between a parking request and the first chronological interval, identifies, based on the degree of compatibility, a device that is associated with a parking request that is compatible with the first chronological interval and the parking location, and providing, to the second device, a notification associated with the parking location.

### CROSS-REFERENCE TO RELATED APPLICATIONS

This application is related to and claims the benefit of U.S. Patent Application No. 61/955,160, filed Mar. 18, 2014, and U.S. Patent Application No. 62/054,444, filed Sep. 24, 2014, each of which is incorporated herein by reference in its respective entirety.

### TECHNICAL FIELD

Aspects and implementations of the present disclosure relate to data processing, and more specifically, to determining parking status and parking availability.

### BACKGROUND

Attempting to park a car in many densely-populated urban areas is often a frustrating experience. Despite automation and optimization in other areas, with respect to parking numerous inefficiencies remain.

### SUMMARY

The following presents a simplified summary of various aspects of this disclosure in order to provide a basic understanding of such aspects. This summary is not an extensive overview of all contemplated aspects, and is intended to neither identify key or critical elements nor delineate the scope of such aspects. Its purpose is to present some concepts of this disclosure in a simplified form as a prelude to the more detailed description that is presented later.

In an aspect of the present disclosure, a processing device receives one or more first inputs from a first device. The processing device processes the one or more inputs to compute a first chronological interval with respect to which a first vehicle is likely to leave a parking location. The processing device receives one or more parking requests from one or more devices, each of the one or more parking requests comprising a current location and a destination. The processing device processes the one or more parking requests to compute, in relation to the parking location, a degree of compatibility between a respective parking request and the first chronological interval. The processing device identifies, based on the degree of compatibility, a second device from the one or more devices that is associated with a parking request that is relatively compatible with the first chronological interval and the parking location. The processing device provides, to the second device, a notification associated with the parking location.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 depicts an illustrative system architecture, in accordance with one implementation of the present disclosure.

FIG. 2 depicts a flow diagram of aspects of a method for determining parking status, in accordance with one implementation of the present disclosure.

FIG. 3 depicts a flow diagram of aspects of a method for determining parking status, in accordance with one implementation of the present disclosure.

FIG. 4 depicts an exemplary parking scenario, in accordance with one implementation of the present disclosure.

FIG. 5 depicts an exemplary parking scenario, in accordance with one implementation of the present disclosure.

FIG. 6 depicts a block diagram of an illustrative computer system operating in accordance with aspects and implementations of the present disclosure.

### DETAILED DESCRIPTION

Aspects and implementations of the present disclosure are directed to determining parking status and parking availability. The systems and methods disclosed can be implemented in technologies including various methods and systems for collecting parking data, analyzing the collected data to determine parking availability, and providing one or more users with information pertaining to such parking availability. In certain implementations, various parking status indicators can be provided/received in conjunction with associated location indicators (e.g., GPS data) and/or chronological indicators (e.g., a timestamp). Such parking status indicators can be processed/analyzed (e.g., together with/in relation to their respective chronological/geographical indicators) to determine whether various vehicles are parking, leaving a parking spot, etc. Such parking status determination(s) (e.g., with respect to a particular vehicle) can be further analyzed/processed to determine and/or predict the availability of parking in a certain location (e.g., at a certain time). A graphical representation (e.g., a map) can be generated based on the referenced determination(s), depicting, for example, geographical regions/areas within which parking is/is not and/or is/is not likely to be available. Additionally, historical parking status determination data can be processed to compute the likelihood of a parking spot becoming open, e.g., at a certain location during a time of day/week/month/year, etc. Additionally, the described technologies can be implemented in conjunction with various navigation technologies, such as in order to compute an optimal path to be traveled to a particular destination in order to improve/maximize the likelihood of a user finding a parking spot (e.g., within a certain radius of the destination).

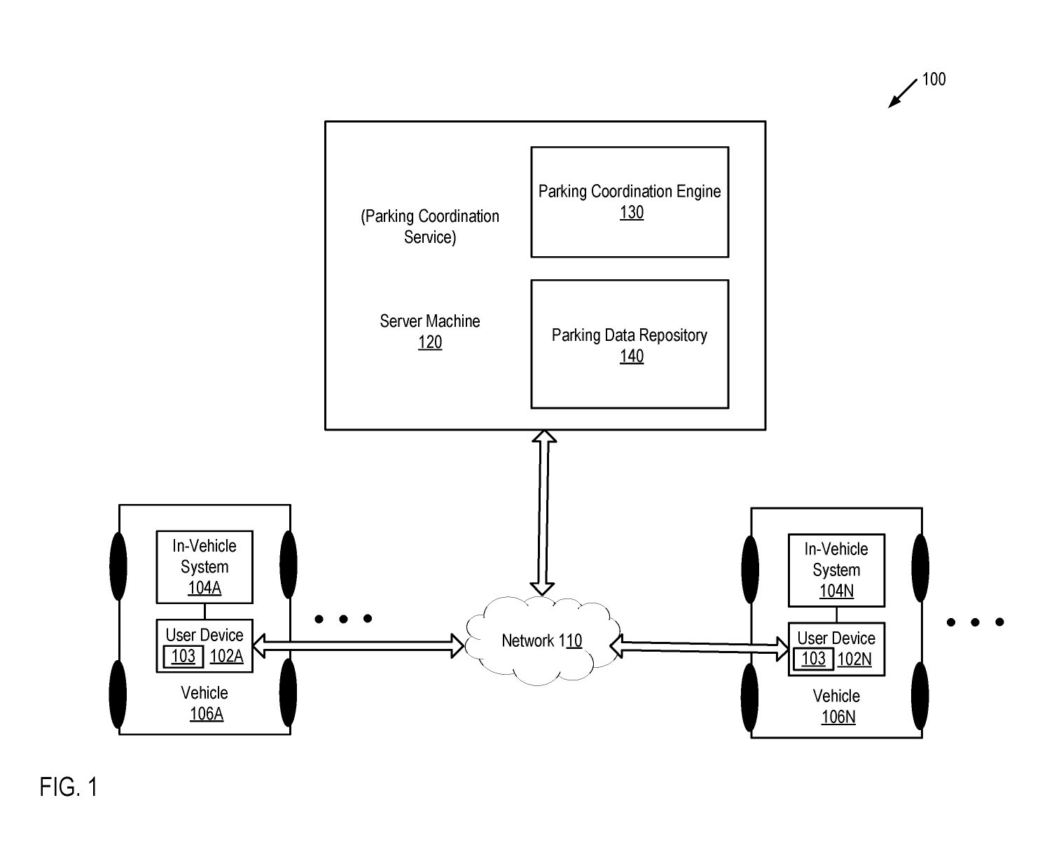

FIG. 1 depicts an illustrative system architecture 100, in accordance with one implementation of the present disclosure. The system architecture 100 includes user devices 102A-N, in-vehicle systems 104A-N, vehicles 106A-N, and server machine 120. These various elements or components can be connected to one another via network 110, which can be a public network (e.g., the Internet), a private network (e.g., a local area network (LAN) or wide area network (WAN)), or a combination thereof.

Each user device 102 can be a rackmount server, a router computer, a personal computer, a portable digital assistant, a mobile phone, a laptop computer, a tablet computer, a camera, a video camera, a netbook, a desktop computer, a media center, a smartphone, a watch, a smartwatch, an in-vehicle computer/system, any combination of the above, or any other such computing device capable of implementing the various features described herein. Various applications, such as mobile applications (‘apps’), web browsers, etc. (not shown) may run on the user device (e.g., on the OS of the user device). As shown in FIG. 1, each user device 102 can also include and/or incorporate various sensors and/or communications interfaces 103. Examples of such sensors include but are not limited to: accelerometer, gyroscope, compass, GPS, haptic sensors (e.g., touchscreen, buttons, etc.), microphone, camera, etc. Examples of such communication interfaces include but are not limited to cellular (e.g., 3G, 4G, etc.) interface(s), Bluetooth interface, WiFi interface, USB interface, NFC interface, etc.

In certain implementations, user device 102 can be connected and/or communicatively coupled to in-vehicle system 104. In vehicle system 104 can include one or more communication interfaces that are integrated/incorporated within a vehicle 106 (e.g., a car, truck, bus, motorcycle, etc.) through which information can be received from and/or transmitted to user device 102. By way of illustration, in-vehicle system 104A can include a Bluetooth interface through which user device 102A can be paired and through which the user device can transmit and/or receive information/content to/from the in-vehicle system (e.g., to utilize aspects of the in-vehicle system to play music or conduct phone calls that originate on the user device). It should be understood that the Bluetooth interface is exemplary and that any number of other communication interfaces that are capable of establishing communication between a user device 102 and an in-vehicle system 104 (e.g., WiFi, USB, etc.) can be similarly implemented. It should also be understood that, in certain implementations, in-vehicle system 104 can include OBD (on-board diagnostics) technologies and/or interfaces (e.g., an OBD port) which, for example, can provide various inputs and information originating at the vehicle 106.

At this juncture it should be noted that while FIG. 1 depicts vehicles 106A and 106N (as well as their corresponding user devices 102 and in-vehicle systems 104), such depiction is for the sake of clarity and brevity. However, in various scenarios (such as those described herein), any number of additional vehicles (and corresponding devices/systems) may also be present. In such scenarios, server machine 120 may receive inputs from multiple devices and can compute determinations, transmit information, etc., based on the inputs received from the various vehicles, devices, and/or systems.

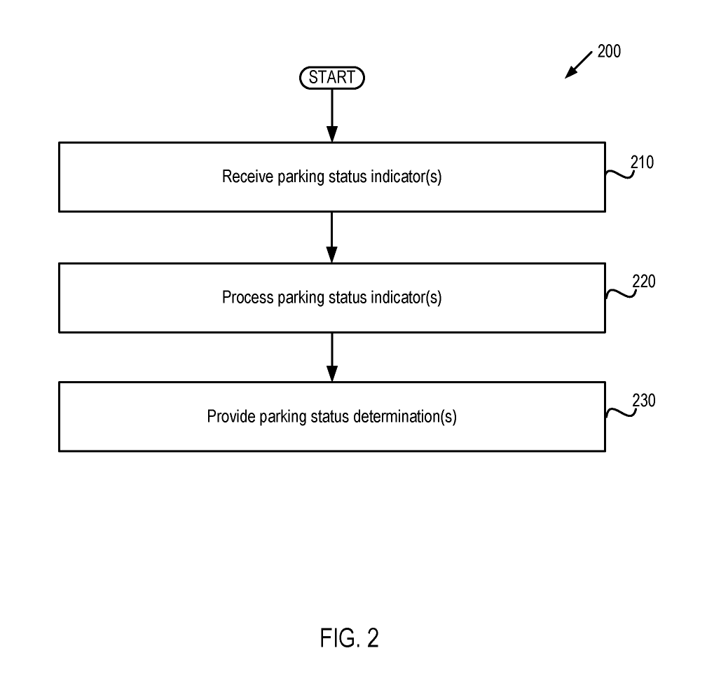

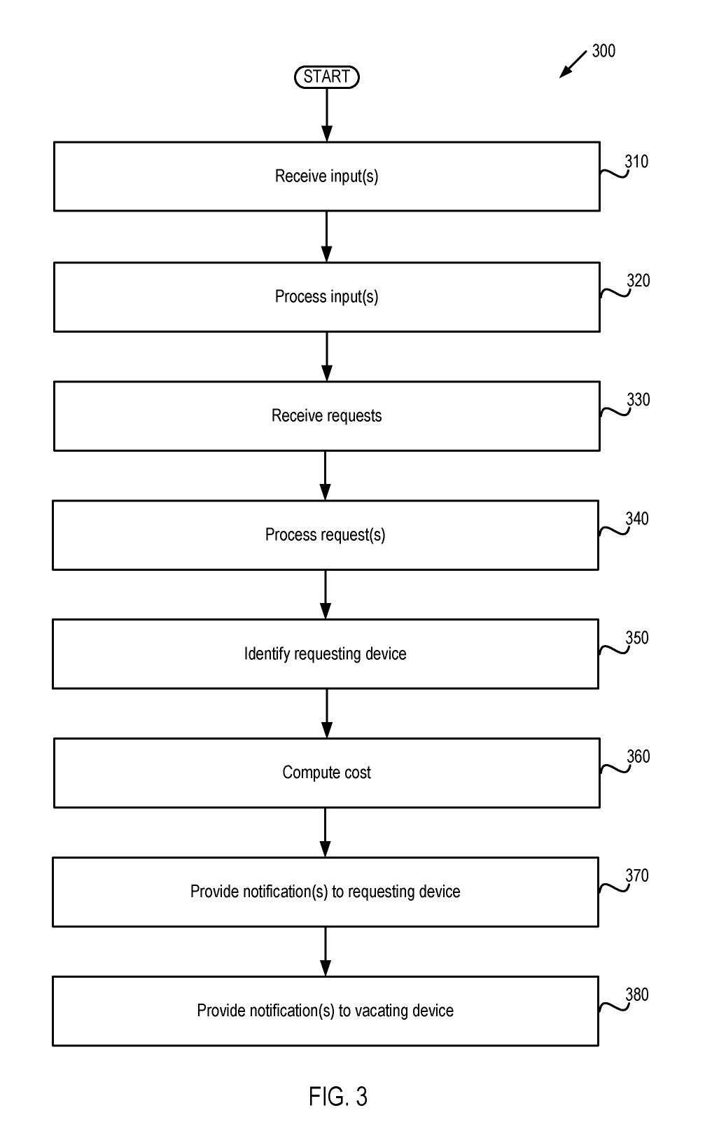

Server machine 120 can be a rackmount server, a router computer, a personal computer, a portable digital assistant, a mobile phone, a laptop computer, a tablet computer, a camera, a video camera, a netbook, a desktop computer, a smartphone, any combination of the above, or any other such computing device capable of implementing the various features described herein. Server machine 120 can include components such as parking coordination engine 130, and parking data repository 140. The components can be combined together or separated in further components, according to a particular implementation. It should be noted that in some implementations, various components of server machine 120 may run on separate machines (for example, parking data repository 140 can be a separate device). Moreover, some operations of certain of the components are described in more detail below with respect to FIGS. 2 and 3.

Parking data repository 140 can be hosted by one or more storage devices, such as main memory, magnetic or optical storage based disks, tapes or hard drives, NAS, SAN, and so forth. In some implementations, parking data repository 140 can be a network-attached file server, while in other implementations parking data repository 140 can be some other type of persistent storage such as an object-oriented database, a relational database, and so forth, that may be hosted by the server machine 120 or one or more different machines coupled to the server machine 120 via the network 110, while in yet other implementations parking data repository 140 may be a database that is hosted by another entity and made accessible to server machine 120. Parking data repository 140 can include parking data (e.g., real time and/or historical data), such as data that corresponds to various aspects of parking spots being occupied and/or vacated at particular times, various aspects of users requesting parking spots (e.g., at particular times in particular areas), as well as various other information that can impact various aspects of parking (e.g., weather, maps that reflect parking meter prices for certain parking spots, maps that reflect various parking regulations such as no parking zones, fire hydrants, etc., calendars that reflect dates on which parking may be prohibited at certain times in certain locations such as due to ‘alternate side parking’ regulations, etc.).

It should be understood that though FIG. 1 depicts server machine 120 and devices 102 and 104 as being discrete components, in various implementations any number of such components (and/or elements/functions thereof) can be combined, such as within a single component/system. For example, in certain implementations user device 102 can incorporate features of server machine 120.

As described in detail herein, various technologies are disclosed that, for example, collect, analyze, disseminate and/or display parking data. Doing so can enable/facilitate drivers to make more informed decisions when parking (or making related decisions, e.g., whether/when to park, etc.). The described technologies can identify available individual parking spots, as well as areas where the probability of finding a parking spot is greater, help direct drivers to such parking spots, help drivers determine the amount of time they are willing to spend looking for a parking spot before parking in a paid garage, and/or allow drivers to optimize their travel plans based upon parking information/determinations. Additionally, a network of vehicles can be established/maintained, and such networked vehicles can share parking-related data, which can also be collected, analyzed, and disseminated (e.g., to other users). In doing so, real time parking data and future parking projections can be generated and provided. In certain implementations, such operations can be performed by and/or in conjunction with parking coordination engine 130.

As described herein, the referenced technologies can include one or more methods of processing/analyzing parking status data/indicators in order to determine the parking status of a particular vehicle, such as at a particular time at a particular location. The referenced indicators can include data received from a car (e.g., from an in-vehicle system), including but not limited to a car's OBD (on-board diagnostics) data, data received from Bluetooth devices installed in the car and data received from a mobile device, including but not limited to a Smartphone, cell phone or tablet device's data.

Among the technologies described herein are techniques for determining the parking status(es) of one or more vehicles (e.g., automobiles) and/or identifying/determining various parking-related events, such as are related to one or more vehicles. In certain implementations, a determination as to whether a vehicle is, for example, parking, or leaving a parking spot can be made as follows.

FIG. 2 depicts a flow diagram of aspects of a method 200 for determining parking status. The method is performed by processing logic that may comprise hardware (circuitry, dedicated logic, etc.), software (such as is run on a general purpose computer system or a dedicated machine), or a combination of both. In one implementation, the method is performed by one or more elements depicted and/or described in relation to FIG. 1, while in some other implementations, one or more blocks of FIG. 2 may be performed by another machine or machines.

For simplicity of explanation, methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At block 210, one or more parking status indicators of a vehicle can be received, identified, and/or otherwise computed, such as in a manner described herein. In certain implementations, such a parking status indicators can include, but are not limited to, on one or more of the following (e.g., it should be understood that a parking status indicator can be a composite of multiple indicators):

Car being turned on or off

Parking gear engaged or disengaged

Parking-break engaged or disengaged

Dashboard or console turned on or off

On board diagnostic information

Status of engine (e g, running/not running, etc.)

Status of tires/axel

Driver seatbelt locked or unlocked

Headlights on/off

Bluetooth connection or disconnection event. This data can be generated by a Bluetooth device installed in the car or from a mobile device connected to the car's Bluetooth device.

Connection/disconnection of a device to an infotainment system such as may be installed/integrated within the vehicle (and/or communications between the device and such a system).

Connection/disconnection of a device to a charger or power source.

Changes in speed and/or acceleration (e.g., based on inputs originating from the device and/or the vehicle, e.g., OBD, etc.).

It should be understood that, while in certain implementations the referenced parking status indicators can be identified/computed at the car (e.g., the car, one or more computing devices integrated therein, and/or one or more external devices, e.g., mobile devices, etc.) in other implementations other device(s) can compute the referenced parking status indicators(s), and/or transmit such indicator(s) to a database. It should be understood that, as described herein, such indicator(s) may reflect a parking status/state of a particular vehicle (e.g., car parking, car un-parking, etc.), and/or may be processed/analyzed (e.g., in relation to one or more additional factors, etc.) to compute such a determination. In other implementations, the car and/or one or more computing devices integrated therein can collect/compute one or more of the referenced data items and transmit such data (e.g., one or more of the items listed above) to another device such as a database, and the referenced parking status event(s), e.g., “car parking/car un-parking,” etc. can be identified/determined at/in relation to the database. In other implementations, the car and/or one or more computing devices can collect/compute one or more of the referenced data items and transmit such data (e.g., one or more of the items listed above) to another device such as a database, and the referenced parking status event(s), e.g., “car parking/car un-parking,” etc. can be identified/determined at/in relation to the database.

By way of illustration, in certain implementations the referenced parking status indicators can correspond to an incidence of connection or disconnection, such as with respect to a Bluetooth device/receiver (and/or any other such communication interface). For example, upon determining that a Bluetooth device (e.g., a smartphone, etc.) has disconnected from another Bluetooth device/receiver (such as a Bluetooth device/receiver installed/integrated within or otherwise associated with a vehicle, such as in order to enable communication between the device and an in-vehicle information system), such an incidence can be determined to be likely to correspond to a ‘parking’ state (reflecting that the user has likely just parked and/or is exiting the vehicle). By way of further example, upon determining that a Bluetooth device has connected to another Bluetooth device/receiver, such an incidence can be determined to be likely to correspond to an ‘un-parking’ state (reflecting that the user has likely just entered the vehicle and/or is likely to be leaving a parking spot). It should be further noted that such determinations (e.g., parking/un-parking determinations) can be further made based on the geographic location/coordinates with respect to which the referenced connection/disconnections occur. For example, a Bluetooth disconnection occurring within a defined proximity of one or more areas at which parking is likely to be occurring (as determined based on other observed instances of Bluetooth disconnections and/or other data) can be determined to be likely to correspond to a parking instance (whereas a Bluetooth disconnection occurring in another area may be relatively less likely to correspond to a parking instance). By way of further example, a Bluetooth connection occurring within a defined proximity of an area at which the same device was previously observed to have disconnected can be determined to be likely to correspond to an ‘un-parking’ instance. It should also be noted that, in various implementations, the referenced indications (e.g., connection and/or disconnection from a Bluetooth device/receiver) can be identified and/or transmitted (e.g., to a central server, such as is described herein) by either or both device(s)/receiver(s).

The referenced parking status determination can be associated with a chronological indicator (e.g., a timestamp, date stamp, etc.) and/or a geographical indicator (e.g., an address, GPS location/coordinates, etc.). Moreover, in certain implementations the referenced chronological indicator and/or geographical indicator can be provided to a central database, whether together with and/or independently of the associated parking status determination.

At block 220, upon receiving the parking status indicator(s) (e.g., at the central database), such indicator(s) can be processed/analyzed, e.g., to determine whether a car (e.g., the vehicle with respect to which such indicators are provided) is parking, parked, un-parking (e.g., leaving a parking space). Additionally, in certain implementations the chronological indicator(s) and/or geographical indicator(s) associated with such an event can also be associated with the referenced determination.

Moreover, in certain implementations the referenced parking status determination (e.g., the status of a car/parking event) can be determined (e.g., based on the various parking status indicators describe herein) by a computing device integrated within and/or in communication with the vehicle itself, and such a determination (e.g., as computed at/in relation to the car or in the mobile device) can be transmitted/sent to a central database together with the referenced chronological and/or geographical indicators. Additionally, in certain implementations the referenced parking status determination can be transmitted together with a time stamp and GPS location (e.g., as opposed to collecting various data point(s) from the car or mobile device and computing the referenced a determination at a central database).

Upon computing and/or receiving such parking status determinations from/in relation to several vehicles (e.g., several vehicles within a certain proximity/distance of one another), such determinations can be further processed/analyzed to determine the availability of one or more parking spots, such as within a particular geographic area.

Moreover, in certain implementations historical data (e.g., the referenced parking status determinations as collected over time) can be processed/analyzed, such as in order to determine various parking characteristics. Such parking characteristics can, for example, pertain to a particular vehicle (reflecting, for example, one or more patterns, trends, tendencies, etc., that may be exhibited by the vehicle, such as with respect to the parking status of such a vehicle. For example, an analysis of the referenced parking status determinations over time may reveal that a particular vehicle generally parks within a particular time window (e.g., 5-6 pm on weekdays) and generally ‘un-parks’ (e.g., leaves a parking spot) within a particular time window (e.g., 8-9 am on weekdays).

At block 230, a parking status determination can be provided. That is, the reference parking status determinations (e.g., as determined with respect to multiple vehicles within a particular geographic location) as well as various associated data items (e.g., timestamp, location, etc.) can be utilized/combined to generate a dynamic mapping that can reflect, for example, where cars are parked (and/or are relatively more likely to be parked) and where parking spots are open/free at a given time (and/or are relatively more likely to be open). It should be understood that, in certain implementations, the referenced mapping can depict the referenced spots via any number of visual indicators, e.g., an icon/shape/color, etc.).

Additionally, in certain implementations the referenced determinations and/or data associated with such determinations can be further utilized, such as to generate a graphical representation such as “heat-map” representation that, for example, utilizes the referenced parking data and/or other data. Such a graphical representation can depict and/or reflect various aspects of a computed probability of finding a parking spot, such as with respect to a given location and/or at a given time. For example, one location (e.g., a street, block, region, etc.) can be depicted as one color, reflecting a relatively high likelihood of finding parking, while another location can be depicted as another color, reflecting a relatively low likelihood of finding parking.

It should be understood that the various technologies described herein (e.g., with respect to computing parking status determinations with respect to various vehicles, computing one or more probabilities of finding parking within a particular location, etc.) can be dynamic, such that they can retrain their parameters on an ongoing basis, such as in order to improve themselves based on newly received/determined data, determinations, etc. As noted, the referenced probability of finding a parking spot within a particular location can be determined, for example, based on various respective parking statuses received from and/or determined in relation to various vehicles, such as vehicles present within a particular geographical location. Moreover, in certain implementations the referenced probability can be further computed based on one or more additional variables, including but not limited to:

Periodicity

Time of day, week, month, year

Weather

Traffic

Public and religious holidays

Parking rules and regulation

Driving rules and regulations

Infrastructure of the city including proximity to major highways, streets, exits/entrances to major highways, known landmarks

Population density within a certain location

Density of retail stores

Known drivers looking for a spot in a location at a time

If user activates a function such as those described herein, the database knows of “active” parkers in a location

Trace GPS data

Parking characteristics of a particular vehicle

Moreover, in certain implementations the various data/determinations described herein can be used predicatively. For example, based on the referenced data/determinations (e.g., current parking status determinations, historical parking status determinations, other information regarding a particular location, e.g., weather, etc.) various predictions/determinations can be made with respect to the likelihood of availability of parking at a future time in a particular location (e.g., given historical parking data, probabilities, etc.).

Such computed determinations, predictions, and/or data can be used to create a map that can depict, for example, when and/or where a spot is likely to open, such as at a particular time. For example, various icons/shapes/colors, etc. can be used to notify a user when a spot is determined to open (or is likely to open).

By way of further example, in certain implementations an icon can change in color/size as the probability that the spot is open changes over time. For example, when a parking spot is determined to open in a given area (e.g., using one or more of the techniques described herein), the probability that the parking spot will remain open (e.g., after a given amount of time) can also be determined (e.g., based on various historical data and/or one or more models trained on such data) for that area. Such a determination can be computed based on, among other things, the time it has historically taken to record a subsequent parking event at the same geographical location after determining that an un-parking event occurred at or near that location

In certain implementations, upon determining that a car has parked at that location, the referenced icon can disappear. Additionally, in certain implementations the icon/shape/color, etc., can be configured to reflect/display the time elapsed since a determination that the spot opened (even if no subsequent parking event has been detected with respect to the spot).

It should be understood that, in certain implementations one or more of the outputs, determinations, data, etc., referenced herein can be combined, mixed, matched, overlaid, etc., such as in any number of variations, in order to generate new maps. Additionally, in certain implementations the referenced determinations, data, etc., can be processed/analyzed, e.g., with respect to a navigation path, such as a navigation path provided by a user indicating a destination that the user is traveling to, in order to determine one or more suggested and/or optimal navigation path(s) that the user can take to a destination which also maximize/improve the probability of the user finding a spot en route to and/or within a certain radius of the destination, and such optimal suggested routes, paths, etc., can be displayed on a map.

Moreover, in certain implementations the referenced determinations, data, etc. can be analyzed/processed to enable insurance companies to change their rates.

Additionally, the referenced determinations/data can be used by other companies analyzing traffic data to increase/improve their understanding of traffic.

The referenced determinations/data can also be used by urban planners and city officials to design cities with better parking systems/options/regulations

In other implementations, various vehicles can be networked to one another, such as in order to share determinations/data that is computed/collected. Such determinations/data can be analyzed, such as in order to provide real time, parking data, e.g., to members of the referenced network.

For example, in certain implementations data originating at an on board diagnostic (OBD) component can be synchronized (‘synced’) and/or otherwise associated with location and/or timestamp information. Such “synched” OBD data can be transmitted to central database (e.g., via software/hardware installed within the vehicle, such as via a device attached to the OBD port which can collect, sync and/or send data, such as to a central database and/or via a mobile device synced/connected to the OBD device, e.g., via Bluetooth, WiFi, etc.).

The referenced “synched” OBD data can then be collected, aggregated, and/or analyzed. In doing so, parking availability, real-time parking data, and/or probabilistic parking data can be computed/determined.

The referenced data/determinations can also be processed/analyzed, such as in order to determine traffic conditions with respect to a particular location.

Additionally, the referenced data/determinations can also be processed/analyzed to determine the availability of parking spots in an area and/or one or more parking characteristics (e.g., of a particular vehicle, type of vehicle, type of driver, etc.), e.g., over time (for example, does a particular vehicle exhibit a “pattern” in their parking?).

The referenced determinations/data can be used to generate a mapping, such as one that can depict where cars are parked and/or where spots are open at a given time. In certain implementations, open spots can be highlighted with an icon/shape/color, filled spots can be displayed as parked cars, or another icon/shape/color, etc., such as is described herein.

Additionally, in certain implementations the referenced determinations and/or data associated with such determinations can be further utilized, such as to generate a graphical representation such as “heat-map” representation that, for example, utilizes the referenced parking data and/or other data. Such a graphical representation can depict and/or reflect various aspects of a computed probability of finding a parking spot, such as with respect to a given location and/or at a given time. For example, one location (e.g., a street, block, region, etc.) can be depicted as one color, reflecting a relatively high likelihood of finding parking, while another location can be depicted as another color, reflecting a relatively low likelihood of finding parking Additionally, it should be understood that the various technologies described herein (e.g., with respect to computing parking status determinations with respect to various vehicles, computing one or more probabilities of finding parking within a particular location, etc.) can be dynamic, such that they can retrain their parameters on an ongoing basis, such as in order to improve themselves based on newly received/determined data, determinations, etc. As noted, the referenced probability of finding a parking spot within a particular location can be determined, for example, based on various respective parking statuses received from and/or determined in relation to various vehicles, such as vehicles present within a particular geographical location. Moreover, in certain implementations the referenced probability can be further computed based on one or more additional variables, including but not limited to:

Periodicity

Time of day, week, month, year

Weather

Traffic

Public and religious holidays

Parking rules and regulation

Driving rules and regulations

Infrastructure of the city including proximity to major highways, streets, exits/entrances to major highways, known landmarks

Population density within a certain location

Density of retail stores

Known drivers looking for a spot in a location at a time

If user activates function such as those described herein, database knowledge of “active” parkers in a location

Trace GPS data

Moreover, in certain implementations the various data/determinations described herein can be used predicatively. For example, based on the referenced data/determinations (e.g., current parking status determinations, historical parking status determinations, other information regarding a particular location, e.g., weather, etc.) various predictions/determinations can be made with respect to the likelihood of availability of parking at a future time in a particular location (e.g., given historical parking data, probabilities, etc.).

Such computed determinations, predictions, and/or data can be used to create a map that can depict, for example, when and/or where a spot is likely to open, such as at a particular time. For example, various icons/shapes/colors, etc. can be used to notify a user when a spot is determined to open (or is likely to open).

By way of further example, in certain implementations an icon can change in color/size as the probability that the spot is open changes over time. For example, when a parking spot is determined to open in a given area (e.g., using one or more of the techniques described herein), the probability that the parking spot will remain open (e.g., after a given amount of time) can also be determined (e.g., based on various historical data and/or one or more models trained on such data) for that area. Such a determination can be computed based on, among other things, the time it has historically taken to record a subsequent parking event at the same geographical location after determining that an un-parking event occurred at or near that location.

In certain implementations, upon determining that a car has parked at that location, the referenced icon can disappear. Additionally, in certain implementations the icon/shape/color, etc., can be configured to reflect/display the time elapsed since a determination that the spot opened (even if no subsequent parking event has been detected with respect to the spot).

It should be understood that, in certain implementations one or more of the outputs, determinations, data, etc., referenced herein can be combined, mixed, matched, overlaid, etc., such as in any number of variations, in order to generate new maps. Additionally, in certain implementations the referenced determinations, data, etc., can be processed/analyzed, e.g., with respect to a navigation path, such as a navigation path provided by a user indicating a destination that the user is traveling to, in order to determine one or more suggested and/or optimal navigation path(s) that the user can take to a destination which also maximizes/improves the probability of the user finding a spot en route to and/or within a certain radius of the destination, and such optimal suggested routes, paths, etc., can be displayed on a map.

Moreover, in certain implementations the referenced determinations, data, etc. can be analyzed/processed to enable insurance companies to change their rates.

Additionally, the referenced determinations/data can be used by other companies analyzing traffic data to increase/improve their understanding of traffic.

The referenced determinations/data can also be used by urban planners and city officials to design cities with better parking systems/options/regulations.

In various implementations, one or more technologies and/or techniques can be employed that are configured to be associated and/or synchronize various data items, such as location (e.g., GPS) indicators, time, and/or and OBD data, and transmits such data to central database.

The referenced data can be analyzed to determine parking availability in a location, to determine when spots are opening in real time, to determine the probability of finding a spot, etc.

Additionally, in certain implementations a network of vehicles configured with the referenced technologies can create a network of data-sharing vehicles based on which real time parking determinations/predictions can be made. As noted, various aspects of the referenced data/determinations can be depicted/displayed as a heat map, showing open spots as they become available (e.g., by changing in shape/color as probability that the availability of the spot changes), and/or as a map of current data (e.g., spots occupied/spots open).

FIG. 3 depicts a flow diagram of aspects of a method 300 for determining parking status. The method is performed by processing logic that may comprise hardware (circuitry, dedicated logic, etc.), software (such as is run on a general purpose computer system or a dedicated machine), or a combination of both. In one implementation, the method is performed by one or more elements depicted and/or described in relation to FIG. 1, while in some other implementations, one or more blocks of FIG. 3 may be performed by another machine or machines.

For simplicity of explanation, methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At block 310, one or more first inputs can be received. In certain implementations, such inputs can be received from a device (e.g., user device 102A as depicted in FIG. 1). Moreover, in certain implementations the referenced inputs can be received from an in-vehicle system (e.g., in-vehicle system 104A as depicted in FIG. 1). In one aspect, block 310 is performed by parking coordination engine 130.

Additionally, in certain implementations such inputs can include one or more motion inputs. Such motion inputs can include inputs originating, for example, from an accelerometer, gyroscope, and/or any other such motion sensor, such as may be incorporated/embedded within and/or otherwise communicatively coupled to user device 102A. As described herein, various aspects of such inputs can be processed and/or analyzed to identify various patterns, signatures, etc., such as those that may correspond to/reflect an incidence of walking, etc.

Additionally, in certain implementations the referenced inputs can include a request for a parking location. By way of illustration, it can be appreciated that the location (e.g., the geographic coordinates, as determined, for example, using a GPS receiver incorporated within a user device 102) at which a user has previously parked can be established/determined in one or more ways (e.g., based on a determination that the user was driving but has now stopped, e.g., for a certain amount of time, based on a user affirmatively indicating that they have parked, etc.). Accordingly, having established a parking location, a user may subsequently request/retrieve such a location (e.g., in order to remember where they have parked). As such, such a request for a parking location can be determined to be likely to indicate that the user is likely to exit such a parking location shortly. It should also be understood that one or more other indications/inputs can also be considered/utilized in conjunction with such a determination (e.g., tracking the location of the device, such as whether it is traveling from its current location in the direction of the parking location), in order to more accurately determine when the parking location is likely to be vacated.

Moreover, in certain implementations the referenced inputs can include inputs that are determined to correlate with various previously received inputs (such as those that may be stored in parking data repository 140) that are determined to coincide with an incidence of unparking (e.g., exiting a parking spot). For example, various inputs (e.g., inputs received from a GPS receiver of the device that correspond to the location/path of the device, motion inputs that correspond to movement of the device, etc.), that have been previously received with respect to a device and which have been observed to be followed by the user exiting a parking space, can be utilized to determine/predict that the user is likely to be exiting a parking space (e.g., upon observing similar/comparable input(s)). By way of illustration, if a user has previously been observed several times walking to a coffee shop prior to getting into their car and going to work, upon observing the user subsequently walking to the coffee shop, it can be determined that the user is likely to be leaving their parking spot shortly.

Additionally, in certain implementations the referenced inputs can include a remote instruction transmitted to a vehicle. For example, it can be appreciated that various applications, devices, services, etc. can be implemented to enable a user to start a car remotely (e.g., to warm up the car in the winter, cool it off in the summer, etc.). Additionally, various other remote commands (e.g., a remote command to unlock or open the doors of the vehicle) can also indicate that the vehicle is likely to exit the parking spot that it occupies shortly. Accordingly, upon determining that such an instruction has been transmitted by a device to a vehicle, it can be determined that such a vehicle it likely to exit the parking spot that it occupies shortly.

Moreover, as has been described herein, it can be appreciated that various inputs can be received based upon which a parking location can be established/determined (e.g., based on various inputs that indicate that the user has stopped driving at a particular location, based on an affirmative indication that the user has parked at a particular location, etc.). Accordingly, having established such a parking location, upon receiving various subsequent input(s) (e.g., in relation to the established parking location), such inputs can be utilized to determine (e.g., with increasing certainty) that the user is likely to exit the parking spot. For example, using various ‘geofencing’ techniques, as are known to those of ordinary skill in the art, various geofences can be established (e.g., at various distances from the parking location), and upon determining that the device 102 is entering one or more geofences that are increasingly proximate to the parking location, it can be determined that the user is increasingly likely to be leaving the parking spot.

At block 320, various inputs (such as those received at 310) can be processed. In doing so, a first chronological interval can be computed. Such a chronological interval can reflect, for example, an interval during which a vehicle (e.g., a parked vehicle) is likely to leave/vacate a parking location. It should be understood that such a chronological interval can correspond to a particular time or time range/window. For example, based on the referenced determinations, it can be computed that the referenced parking spot is likely to be vacated during the 3:04 PM-3:08 PM time interval. In one aspect, block 320 is performed by parking coordination engine 130.

By way of illustration, in certain implementations various inputs, such as motion inputs (such as may be received at 310) can be processed to identify an input signature, pattern, etc., that corresponds to and/or reflects a user walking. Such motion inputs can be processed with respect to a current location of the device and the parking location to compute/determine (e.g., based on the speed they are walking at and the distance to the vehicle) how long it is likely to take the user to arrive at the car/exit the parking spot (and thereby also determine the referenced chronological interval, within which the parking spot is likely to be vacated).

Moreover, in certain implementations one or more inputs (such as those received at 310) can be processed in relation other inputs (e.g., inputs that are subsequently received). In doing so, a degree to which a device (e.g., user device 102A) is increasingly proximate to a parking location can be determined. For example, as has been described herein, a parking location can be established/determined based on various inputs (e.g., based on various inputs that indicate/reflect that the user has stopped driving at a particular location, based on an affirmative indication that the user has parked at a particular location, etc.). Having established such a parking location, upon receiving the referenced subsequent input(s) (e.g., in relation to the established parking location), it can be determined (e.g., with increasing certainty) that the user is likely to exit the parking spot. For example, using various ‘geofencing’ techniques, as are known to those of ordinary skill in the art, one or more geofences can be established (e.g., at various distances/radii from the parking location), and upon determining that the device 102 is entering geofence(s) that are increasingly proximate to the parking location, it can be determined that the user is increasingly likely to be leaving the parking spot. Accordingly, based on the degree to which the device is determined to be increasingly proximate to the parking location (e.g., by entering one or more geofences that are increasingly proximate to the parking location), a chronological interval with respect to which the vehicle is likely to leave a parking location/the parking location is likely to be vacated can be determined.

At this juncture it should be noted that the referenced geofencing techniques (and/or any other such region monitoring techniques/technologies) can be employed in conjunction with the various technologies described herein. Such technologies, for example, establish a geographic perimeter (e.g., various concentric circles surrounding a particular location such as a parking spot) and can monitor/log events, such as each time a device crosses the referenced perimeter (into and/or out of such a geofenced region), as determined, for example, based on a GPS receiver incorporated within the device. For example, such region monitoring techniques can be cross-referenced with other device sensor data (including but not limited to speed, accelerometer inputs, Bluetooth and device charging status data, etc.), to determine parking activity. By way of illustration, instances of crossing the referenced geofence region (e.g., by a particular device) can be compared to, processed in relation to, and/or cross-referenced to other inputs (sensor inputs, location inputs, etc.) in order to determine the location of parking events. For example, using grids of such regions it can be determined which regions a user device has entered and which they have not, and, based on an identification of a region (or regions) that a user has entered and not yet exited, a likely location of a parking event can be determined (in conjunction with determinations computed based on the referenced sensor data).

Moreover, upon establishing the location of a parking event, various regions surrounding such a location can be monitored. In doing so, a probabilistic predictive model can be generated, reflecting the likelihood of the parking space being vacated (which, for example, can reflect not only binary parking/unparking events, but also the likelihood that such events are to occur). For example, a determination that a user device has exited a region surrounding the location of a parking event, and a subsequent determination that the user device has reentered such a region can affect (e.g., increase) a determination of the likelihood that the parking space is to be vacated shortly.

Additionally, as noted, the referenced region crossings (e.g., instances of exit/entry into/out of various regions) can be compared to, processed in relation to, and/or cross-referenced to other inputs (sensor inputs, location inputs, etc.) in order to determine the location of parking events and further enhance the accuracy of a predictive model. For example, in a scenario in which a device is determined to be entering regions close to the parking location and the device is also determined to be traveling directly toward the parking location (as determined based on location data), and it can also be determined that the user is walking (as determined from accelerometer data, such as based on an accelerometer signature/pattern that corresponds to walking), it can be determined that the corresponding vehicle (e.g., the vehicle occupying the referenced parking space) is relatively likely (or relatively more likely) to be vacating the space shortly. By way of further example, upon determining that the device has entered regions close to the parking location, and further determining that the device is being charged, it can be determined that it is relatively likely (or relatively more likely) that the space will be vacated shortly. In these ways, region monitoring can increase the predictive weight placed on indicators originating from other sources (e.g., sensor inputs, etc.).

Moreover, in certain implementations the referenced inputs (such as those received at 310) can be processed in order to compute a chronological interval during which a parking location is likely to remain vacant (and/or a likelihood that a vacant parking location is still vacant). That is, it can be appreciated that, as described herein, various determinations can be made with respect to whether or not a parking space is occupied or vacant (e.g., based on various inputs, based on an affirmative indication from a user that the parking space is vacant, etc.). Accordingly, upon determining that a parking space is vacant, a determination can be made with respect to whether the space still remains vacant and/or a chronological interval can be computed reflecting, for example, an interval during which the parking space can be determined/projected to remain vacant. It should be understood that such a chronological interval can correspond to a particular time or time range/window and/or a time duration. For example, based on the referenced determinations, it can be determined that the referenced vacant parking spot is likely to remain vacant for the next three minutes (and/or during the 3:04 PM-3:07 PM time interval). It should be understood that such a chronological interval can be computed based on various factors, such as historical parking data (reflecting how long parking spaces in the same or similar area(s) remain vacant during the same or similar time of day, year, etc.) and/or current parking data (reflecting, for example, current/recent parking activity, such as within the same/similar location, which can reflect, for example, the amount of time that parking spaces remain vacant in the area as well as current parking activity).

At block 330, one or more parking requests can be received. In certain implementations, such parking requests can be received from one or more devices (e.g., user device 102N and/or in-vehicle system 104A as depicted in FIG. 1). Moreover, in certain implementations, the referenced parking requests can include various data items/parameters such as a current location (e.g., a current location of the user device 102N and/or the vehicle 106N) and/or a destination (e.g., a destination to which the user is traveling towards). In one aspect, block 330 is performed by parking coordination engine 130.

It should be understood that while in certain implementations the referenced parking requests may be ‘explicit’ or ‘direct’ (in that the referenced user affirmatively indicates their desire to park, e.g., in a particular location—e.g., by indicating, such as within a parking coordination application executing on device 102, that the user wishes to park at/close to a current location and/or a particular destination), in other implementations such requests can be generated based on various determinations that can be made, for example, based on various ‘implicit’ inputs or indications that may reflect that the user is likely to be looking for parking in the referenced location. For example, various motion inputs and/or patterns thereof (e.g., the user stopping with a greater degree of frequency, such as in the middle of the street, the user circling a block or traveling repeatedly around several blocks, reflecting that the user is likely looking for parking in such a location, etc.) can reflect that a user is likely to be looking for parking.

Moreover, it should be further understood that, in certain implementations, a user that is seeking parking can provide one or more inputs, such as in relation to an application (e.g., a parking coordination application) executing on a device 102. Such inputs can include, for example, an indication or selection by the user that they wish to park in a particular location (e.g., as close as possible to their current location, as close as possible to a destination, etc.). Based on information/determinations that reflect a current (and/or future) availability of parking spots within the selected area (such as may be determined, for example, by parking coordination engine 130 and/or based on data from parking data repository 140), the requesting user can be provided/presented with a graphical interface (e.g., a map) that depicts various available parking spots (e.g., within a particular area). The parking coordination application can then enable the user to select a parking spot from among those displayed. Upon receiving a selection of such a parking spot, the selected spot can be assigned to the selecting user, such that, for example, the same spot will no longer be depicted as being available to other users requesting parking (e.g., in the same area). In certain implementations, the selected spot can remain assigned to the selecting user (and thus is not depicted as being available to other requesting users) for at least a certain amount of time (e.g., five minutes) and/or until it can be determined, for example, that the selecting user has parked somewhere else and thus no longer needs the selected parking space (at which point the space can be ‘released’ and can be viewable again by other requesting users).

It should also be noted that, in certain implementations, a requesting user may be precluded from requesting a parking space, such as with respect to a particular location/destination. For example, in a scenario in which the requesting user is relatively far from the desired parking location (and/or can be determined not to be likely to arrive at the desired parking location within a defined time window/threshold, e.g., on account of traffic, etc.), the user can be precluded from requesting a parking space (until, for example, the user is determined to be closer and/or likely to be able to arrive at the parking location sooner). In doing so, the availability of parking spaces can be reserved for those users who are determined to be capable of utilizing such spaces within a relatively short time after the spaces are vacated.

At block 340, one or more parking requests (such as those received at 330) can be processed. In doing so, a degree of compatibility can be computed (e.g., in relation to a parking location at which a vehicle has been determined to be parked), such as between a parking request (such as a parking request received at 330) and a chronological interval (such as the chronological interval computed at 320). That is, having computed a chronological interval (such as is described at 320) that reflects a time interval within which a parking space at a particular location is likely to be vacated, and having received (e.g., at 330) a parking request with respect to another location, a degree of compatibility between the parking request (which may be in relation to one location) and the chronological interval (which may relate to a parking space in another location) can be computed. In one aspect, block 340 is performed by parking coordination engine 130.

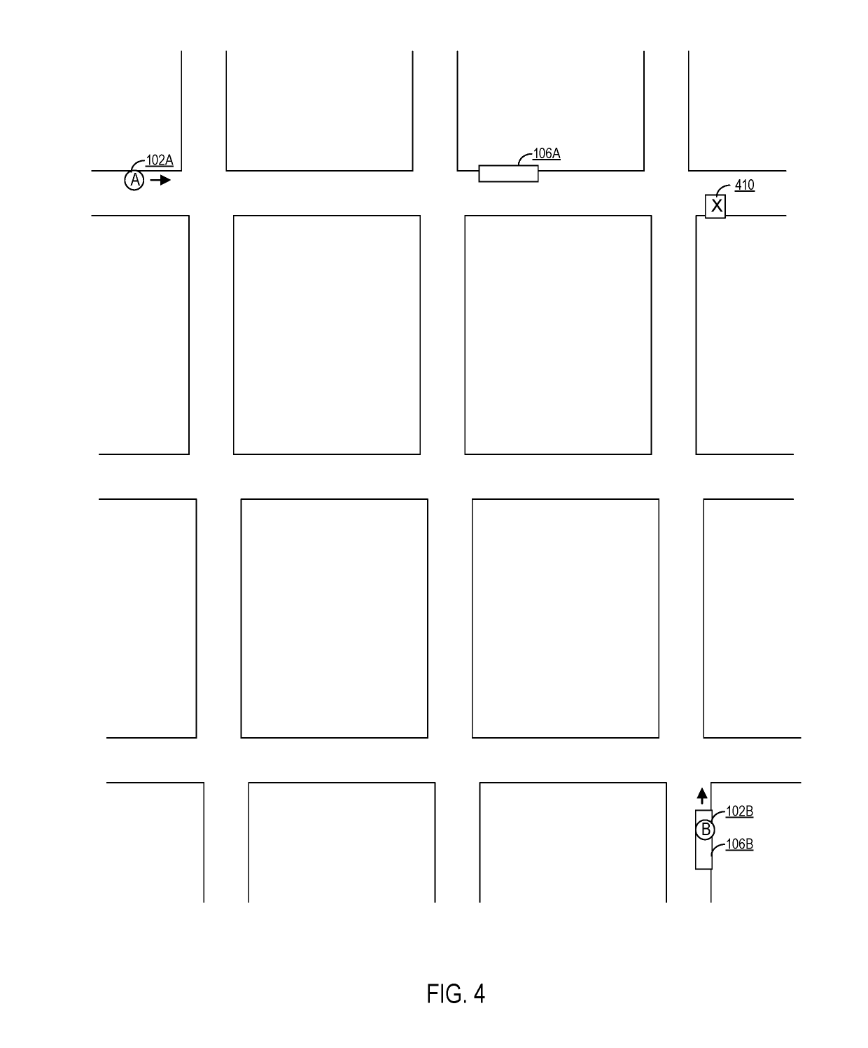

Moreover, in certain implementations a current location and/or a destination associated with a device (e.g., the device that provided the parking request) can be processed, such as in order to compute a chronological interval with respect to which the requesting device is capable of arriving at the parking location. By way of illustration, FIG. 4 depicts an exemplary scenario in which user ‘A’ (operating user device 102A) is walking towards his/her vehicle 106A (based upon which it can be determined that the parking space occupied by vehicle 106A is likely to be vacated shortly, e.g., in approximately the amount of time it will take user ‘A’ to walk to the car and drive off, e.g., in 2-3 minutes), while user ‘B’ (driving in vehicle 106B and operating device 102B) is driving towards destination ‘X’ (410), at which point the user is likely to begin searching for a vacant parking space. Accordingly, the chronological interval within which vehicle 106A is likely to vacate the parking space (e.g., within 2-3 minutes) can be processed in relation to the parking request provided with respect to vehicle 106B (e.g., location ‘X’) to determine the degree to which the request is compatible with the parking location that is to be vacated.

It should be understood that various factors can be accounted for in determining such compatibility. For example, the distance between the intended destination of the requesting user (e.g., location ‘X’) and the vacated parking space (the location of vehicle 106A) can be accounted for (such that, the greater the distance from the intended destination, the less compatible the vacating space is with respect to the parking request. Moreover, as noted, the chronological interval within which vehicle 106B can be determined to be likely to be capable of arriving at the location of the parking space of vehicle 106A can be processed in relation to the chronological interval within which vehicle 106A is likely to vacate the parking space in order to determine the degree to which the respective chronological intervals are compatible. Thus, with respect to the scenario depicted in FIG. 4, if it is, for example, determined that the parking space of vehicle 106A is likely to be vacated within the next 2-3 minutes and it is also determined that vehicle 106B is only likely to arrive at the location of the parking space within the next 15-17 minutes, it can be determined that such respective chronological intervals are not likely to be compatible with one another (at least, for example, during a time of day/week during which vacant parking spaces are often reoccupied within a shorter time duration than the expected arrival time of vehicle 106B).

It should also be noted that any number of additional factors can be accounted for in determining the compatibility of a vacating parking space with a parking request. For example, in a scenario in which the sizes of the vehicle that is vacating the parking space (e.g., vehicle 106A as shown in FIG. 4) and/or the vehicle with respect to which the parking request was provided (e.g., vehicle 106B as shown in FIG. 4) can be determined (such as may be computed, determined, and/or identified based on make/model information associated with the vehicle), such respective sizes can be accounted for in determining the referenced degree of compatibility. Thus, for example, in a scenario in which the vacating vehicle is determined to be a relatively small car while the requesting vehicle is determined to be a relatively large car, it may be determined that the vacating space may be relatively less compatible with the parking request (as the larger vehicle may not fit within the parking space vacated by the smaller vehicle).

Additionally, in certain implementations various historical (and/or real-time) factors and/or trends can be accounted for in determining the referenced compatibilities. For example, upon determining (based on historical and/or real-time data) that parking spaces are being vacated frequently in a particular location (e.g., on a weekday morning when many people are leaving for work), a higher compatibility threshold can be applied when identifying/selecting a compatible parking space (for example, waiting for a parking space that is closer to the indicated destination to become available in a scenario in which it has been determined to be likely that parking spaces are being vacated frequently in such an area at such a time). Conversely, upon determining that parking spaces are being vacated relatively less frequently in a particular location (e.g., late at night when relatively few people are driving), a lower compatibility threshold can be applied when identifying/selecting a compatible parking space (for example, by selecting an available parking space that may be further away from the indicated destination in a scenario in which it has been determined to be unlikely that a closer parking space will become available in such an area at such a time).

At block 350, a device from among those requesting devices (e.g., at 330) can be identified. In certain implementations, such a device can be identified based on the device being associated with a parking request that is relatively compatible with the first chronological interval and/or the parking location (as determined, for example, based on the degree of compatibility computed at 340. Moreover, as described in relation to 340, in certain implementations the requesting device can be identified based on a degree of compatibility between a chronological interval computed with respect to a likelihood that one vehicle is likely to be vacating a parking location and a chronological interval computed with respect to a likelihood that another vehicle is likely to be capable of arriving at the same parking location. In one aspect, block 350 is performed by parking coordination engine 130.

At block 360, a cost can be computed. In certain implementations, such a cost can be computed with respect to a device (e.g., the device that provided the parking request, such as at 330) and the parking location. That is, it can be appreciated that in considering whether or not to utilize a particular parking space, a user may be likely to consider various costs that may be associated with such a space. For example, in certain implementations a monetary cost can be computed with respect to a parking location, reflecting an estimated (or actual) fee (e.g., a parking meter fee, e.g., three dollars per hour) associated with the parking location. By way of illustration, in the scenario depicted in FIG. 4, upon determining (such as in a manner described herein) that the parking location of vehicle 106A may be a compatible parking space for vehicle 106B, a cost associated with parking in such a space can also be computed (and provided to the requesting device, such as in a manner described herein). Moreover, in certain implementations a cost can be computed which reflects/corresponds to the degree to which a particular parking space is (or is not) likely to be convenient for the requesting device/user. For example, such a cost can reflect/correspond to the distance between the parking location and the intended destination of the requesting device/user. By way of illustration, as depicted in FIG. 4, the distance between destination 410 of the requesting device 102B and the parking location of vehicle 106A (which is being vacated) can be computed, and such distance can also be accounted for/reflected in the computation of cost associated with a parking space (such that, for example, the further the distance from the intended destination, the further the user will have to walk, thereby increasing the ‘cost’ of utilizing the parking space with respect to convenience to the user). In other implementations, various other factors/aspects can also be considered/accounted for in computing the referenced cost, such as various parking regulations (e.g., whether parking regulations dictate that the parking space will need to be vacated at a certain time, such as due to ‘alternate side’ parking regulations, etc.). In one aspect, block 360 is performed by parking coordination engine 130.

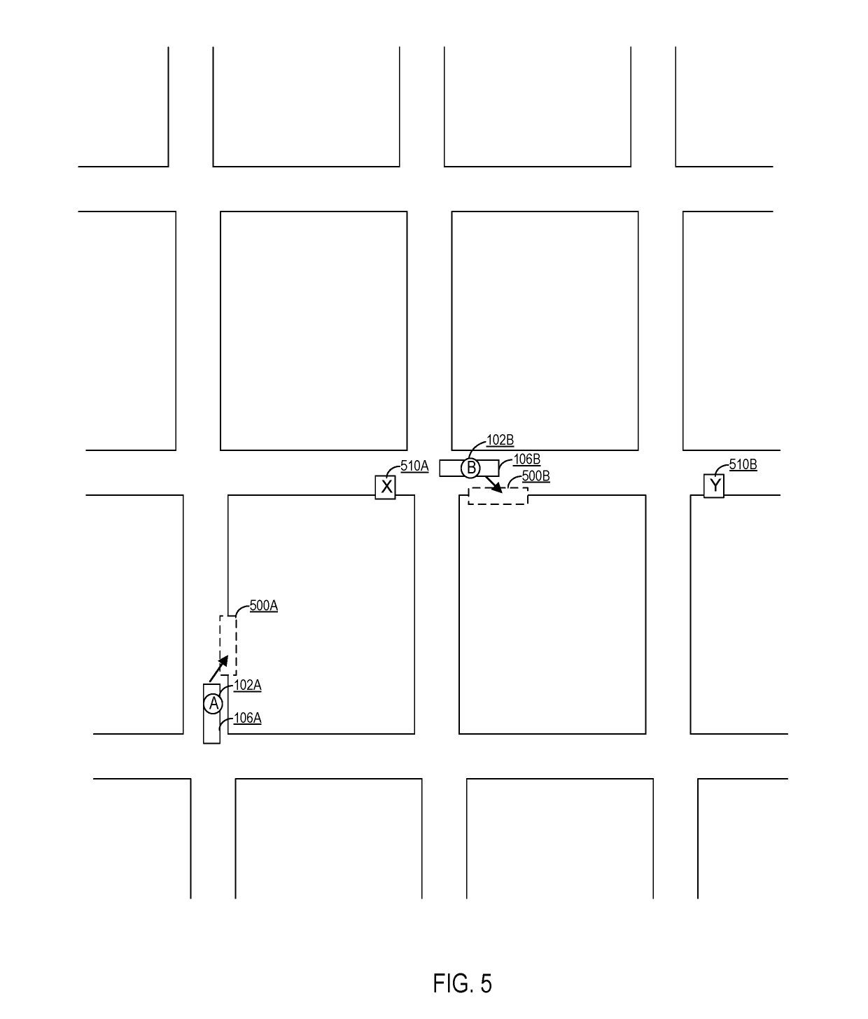

Moreover, in certain implementations the referenced cost can be computed and/or accounted for with respect to several parking requests/vacating parking spots. For example, it can be appreciated that while with respect to a single independent user it may be advantageous for the user to park in a parking location that is closest to his/her intended/desired destination, when accounting for the considerations of multiple users seeking parking, such an arrangement does not necessarily benefit all parties (in the aggregate/on average) optimally. By way of illustration, FIG. 5 depicts an exemplary scenario in which two users (user ‘A,’ utilizing device 102A within vehicle 106A and user ‘B’ utilizing device 102B within vehicle 106B) that are traveling to respective destinations (destination ‘X’ (510A) for user A, and destination ‘Y’ (510B) for user ‘B’) which are relatively close to one another and thus have requested parking in relatively similar locations. Currently, two parking spaces (500A and 500B) have been determined to be vacant. In such a scenario, it can be appreciated that while, with respect to user ‘A’ alone, parking space 500B is ideal (in that it is a relatively short distance to destination ‘X’). However, it can be appreciated that by allocating space 500B to user ‘A,’ user ‘B’ may only have the option of parking in space 500A (which, as shown in FIG. 5, is a considerably longer distance to destination ‘Y,’ and may be outside the distance that user ‘B’ has indicated that he/she is willing to park from his/her destination). Accordingly, in certain implementations, upon receiving various respective requests for parking (e.g., within a particular location), an aggregate (e.g., average) cost (as noted, cost can pertain to any number of items, such as cost with respect to distance from a parking space to the destination of the requesting user, monetary cost, degree of inconvenience with respect to parking regulations, degree of compliance with user preferences such as the maximum distance from their destination that the user is willing to park, etc.) can be computed (e.g., with respect to the various requesting users) and the various available parking spaces/parking spaces that are determined to be likely to be vacant/vacating can be allocated to the requesting users in a manner that reduces and/or optimizes (e.g., for the lowest possible aggregate cost) the aggregate costs across the various requesting users. Thus, for example, in the scenario depicted in FIG. 5, parking space 500A can be allocated to user ‘A’ (and the user can be notified accordingly, such as in the manner described herein) and space 500B can be allocated to user ‘B.’ It can be appreciated that, in doing so, though user ‘A’ may end up parking somewhat further away from destination ‘X’ (resulting in a somewhat higher ‘cost’), as a result user ‘B’ will not have to park in space 500A (which, on account of it being considerably further away from destination ‘Y,’ would result in a considerably higher ‘cost’ with respect to user ‘B,’ as well as a higher aggregate cost for users ‘A’ and ‘B’ together). It should be noted that the referenced scenario(s) are exemplary and that the referenced technologies can be implemented in any number of other scenarios, such as with respect to any number of additional requesting users, available parking spaces, etc., in order to optimize the allocation of such spaces to requesting users. It should also be noted that the referenced techniques can be similarly implemented with respect to a group of users (e.g., a fleet of cars, enabling improved/optimized allocation of available parking spaces across the various cars that make up the fleet).

At block 370, a notification can be generated and provided, such as to a requesting device (or devices) (such as the device identified at block 350). In certain implementations, such a notification can include information associated with the parking location (e.g., the parking location that is being vacated, such as is computed/determined at 310 and/or 320). For example, a notification can be generated and provided to a requesting device (e.g., the device identified at 350) notifying the user of the location of the parking space that is being vacated. By way of illustration, in the scenario depicted in FIG. 4, device 106B can be provided with a notification that includes the location of the parking space occupied by vehicle 106A (e.g., by displaying a map overlaid with an indicator that corresponds to the location of the parking space being vacated, by providing navigation instructions to the location of the parking space being vacated, etc.). Moreover, in certain implementations various additional data items can also be included in such a notification. For example, a graphical representation (e.g., a ‘street view’) of the parking location can be provided, such as in order to better orient the user to the specific location of the parking space. By way of further example, one or more identifying characteristics of the vehicle that is vacating the parking space (e.g., the make, model, color, etc., of the vehicle) can be provided in the referenced notification. In doing so, the requesting user can more easily identify the location of the parking space being vacated. By way of yet further example, the referenced notification can include information pertaining to the chronological interval within which the parking space is likely to be vacated (and/or the actual time that the parking space has been vacated). For example, the requesting device can be provided with updates pertaining to the status of the user device associated with the vehicle that is likely to be vacating the parking space (e.g., that the device is 2-3 minutes away from the vehicle, such as is depicted in FIG. 4 and described herein) and/or with updates pertaining to an actual status of the device/vehicle (e.g., that the vehicle vacated the spot 2-3 minutes ago). In one aspect, block 370 is performed by parking coordination engine 130.

At block 380, a notification can be generated and provided, such as to the device associated with the vehicle that is vacating the parking space. In certain implementations, such a notification can correspond to the requesting device (e.g., the device identified at 350). That is, it can be appreciated that, in certain scenarios it can be advantageous for the user that is vacating the parking space to be notified with respect to various aspects of the requesting user, such as in order to better enable the requesting user to utilizing the parking space being vacated (e.g., in a scenario in which the vacating user can wait until the requesting user arrives to enable the requesting user to utilize the parking space). For example, in certain implementations such a notification (that is provided to the device associated with the vehicle that is vacating the parking space, e.g., vehicle 106A as shown in FIG. 4) can indicate a current location of the requesting device and/or an estimated arrival time of the second device to the parking space (based upon which, for example, the user that is vacating the space can decide whether or not to wait until the requesting user arrives). By way of further example, in certain implementations one or more identifying characteristics of the requesting vehicle (e.g., the make, model, color, etc., of the vehicle) can be provided in the referenced notification. In doing so, the user that is vacating the parking space can more easily identify the requesting user who wishes to utilize the space. In one aspect, block 380 is performed by parking coordination engine 130.

It should also be noted that while the technologies described herein are illustrated primarily with respect to parking coordination, the described technologies can also be implemented in any number of additional or alternative settings or contexts and towards any number of additional objectives.

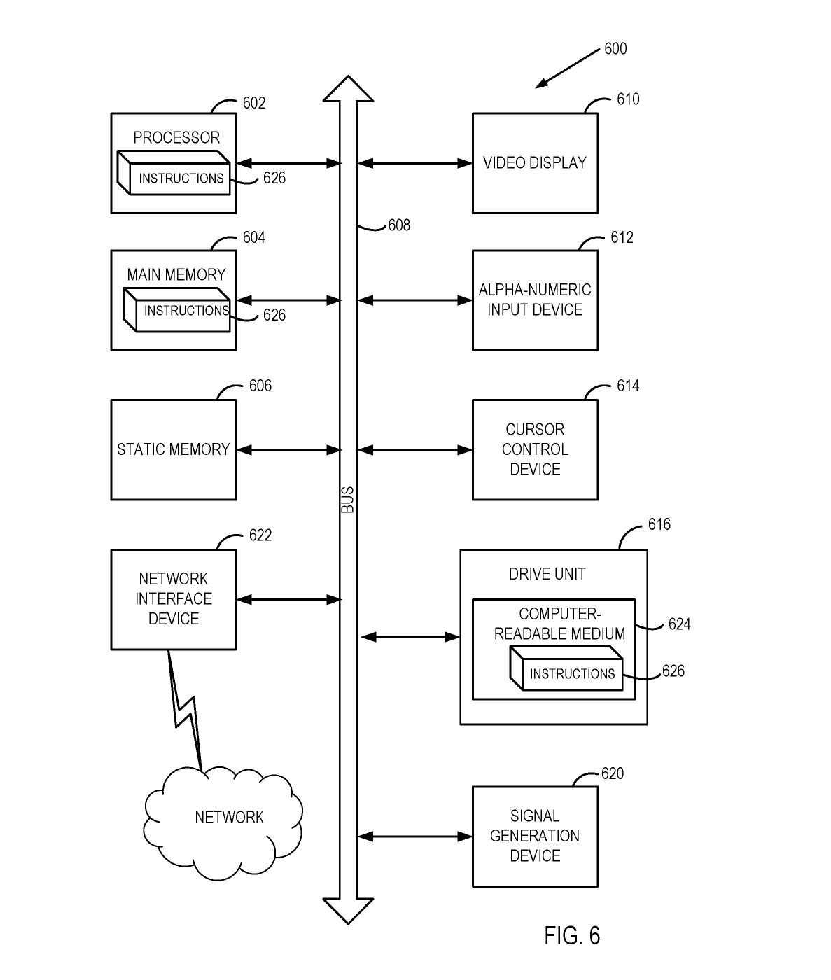

FIG. 6 depicts an illustrative computer system within which a set of instructions, for causing the machine to perform any one or more of the methodologies discussed herein, may be executed. In alternative implementations, the machine may be connected (e.g., networked) to other machines in a LAN, an intranet, an extranet, or the Internet. The machine may operate in the capacity of a server machine in client-server network environment. The machine may be a computing device integrated within and/or in communication with a vehicle, a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 600 includes a processing system (processor) 602, a main memory 604 (e.g., read-only memory (ROM), flash memory, dynamic random access memory (DRAM) such as synchronous DRAM (SDRAM)), a static memory 606 (e.g., flash memory, static random access memory (SRAM)), and a data storage device 616, which communicate with each other via a bus 608.

Processor 602 represents one or more general-purpose processing devices such as a microprocessor, central processing unit, or the like. More particularly, the processor 602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 602 may also be one or more special-purpose processing devices such as an application specific integrated circuit (ASIC), a field programmable gate array (FPGA), a digital signal processor (DSP), network processor, or the like. The processor 602 is configured to execute instructions 626 for performing the operations discussed herein.

The computer system 600 may further include a network interface device 622. The computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse), and a signal generation device 620 (e.g., a speaker).

The data storage device 616 may include a computer-readable medium 624 on which is stored one or more sets of instructions 626 (e.g., instructions executed by server machine 120, etc.) embodying any one or more of the methodologies or functions described herein. Instructions 626 may also reside, completely or at least partially, within the main memory 604 and/or within the processor 602 during execution thereof by the computer system 600, the main memory 604 and the processor 602 also constituting computer-readable media. Instructions 626 may further be transmitted or received over a network via the network interface device 622.

While the computer-readable storage medium 624 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In the above description, numerous details are set forth. It will be apparent, however, to one of ordinary skill in the art having the benefit of this disclosure, that embodiments may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “processing,” “providing,” “identifying,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Aspects and implementations of the disclosure also relate to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general purpose systems may be used with programs in accordance with the teachings herein, or it may prove convenient to construct a more specialized apparatus to perform certain operations In addition, the present disclosure is not described with reference to any particular programming language. It will be appreciated that a variety of programming languages may be used to implement the teachings of the disclosure as described herein.

It is to be understood that the above description is intended to be illustrative, and not restrictive. Many other embodiments will be apparent to those of skill in the art upon reading and understanding the above description. Moreover, the techniques described above could be applied to practically any type of data. The scope of the disclosure should, therefore, be determined with reference to the appended claims, along with the full scope of equivalents to which such claims are entitled.

1. A method comprising:
receiving one or more first inputs from a first device;
processing the one or more inputs to compute a first chronological interval with respect to which a first vehicle is likely to leave a parking location;
receiving one or more parking requests from one or more devices, each of the one or more parking requests comprising a current location and a destination;
processing, by a processing device, the one or more parking requests to compute, in relation to the parking location, a degree of compatibility between a respective parking request and the first chronological interval;
identifying, based on the degree of compatibility, a second device from the one or more devices that is associated with a parking request that is relatively compatible with the first chronological interval and the parking location; and
providing, to the second device, a notification associated with the parking location.

2. The method of claim 1, wherein receiving one or more first inputs comprises receiving one or more motion inputs.

3. The method of claim 2, wherein processing the one or more first inputs comprises processing the one or more motion inputs to identify an input signature that corresponds to walking.

4. The method of claim 3, wherein processing the one or more first inputs further comprises processing the one or more motion inputs with respect to a current location of the first device and the parking location to compute the first chronological interval.

5. The method of claim 1, wherein processing the one or more parking requests comprises processing a current location and a destination associated with the second device to compute a second chronological interval with respect to which the second device is capable of arriving at the parking location.

6. The method of claim 5, wherein identifying the second device comprises identifying the second device based on a degree of compatibility between the first chronological interval and the second chronological interval.

7. The method of claim 1, further comprising providing, to the first device, a notification associated with the second device.

8. The method of claim 7, wherein the notification associated with the second device comprises a current location of the second device.

9. The method of claim 7, wherein the notification associated with the second device comprises an estimated arrival time of the second device.

10. The method of claim 1, further comprising computing a cost with respect to the second device and the parking location.

11. The method of claim 10, wherein computing the cost comprises computing a distance between the parking location and the destination.

12. The method of claim 10, wherein computing the cost comprises computing a fee associated with the parking location.

13. (canceled)

14. The method of claim 1, wherein the one or more inputs comprise one or more inputs that are determined to correlate with one or more previously received inputs that are determined to coincide with an incidence of unparking.

15. The method of claim 1, wherein the one or more inputs comprise a remote instruction transmitted to the first vehicle.

16. The method of claim 1, wherein receiving one or more first inputs from a first device comprises:
receiving a first input from the first device, the first input defining the parking location; and
receiving a second input from the first device, the second input corresponding to a subsequent location of the first device.

17. The method of claim 16, wherein processing the one or more inputs comprises:
processing the first input in relation to the second input to determine a degree to which the first device is increasingly proximate to the parking location; and
based on the degree to which the first device is increasingly proximate to the parking location, computing the first chronological interval with respect to which a first vehicle is likely to leave a parking location.

18. The method of claim 1, further comprising computing an aggregate cost with respect to the one or more parking requests.

19. The method of claim 18, wherein identifying the second device from the one or more devices, comprises identifying, based on the degree of compatibility and the aggregate cost, the second device from the one or more devices.

20. A system comprising:
a memory; and
a processing device, coupled to the memory, to:
receive one or more first inputs from a first device;
process the one or more inputs to compute a first chronological interval with respect to which a parking location is likely to remain vacant;
receive one or more parking requests from one or more devices, each of the one or more parking requests comprising a current location and a destination;
process the one or more parking requests to compute, in relation to the parking location, a degree of compatibility between a respective parking request and the first chronological interval;
identify, based on the degree of compatibility, a second device from the one or more devices that is associated with a parking request that is relatively compatible with the first chronological interval and the parking location; and
provide, to the second device, a notification associated with the parking location.

21. A non-transitory computer readable medium having instructions stored thereon that, when executed by a processing device, cause the processing device to:
receive one or more first inputs from a first device;
process the one or more inputs to compute a first chronological interval with respect to which a first vehicle is likely to leave a parking location;
receive one or more parking requests from one or more devices, each of the one or more parking requests comprising a current location;
process the one or more parking requests to compute, in relation to the parking location, a degree of compatibility between a respective parking request and the first chronological interval;
identify, based on the degree of compatibility, a second device from the one or more devices that is associated with a parking request that is relatively compatible with the first chronological interval and the parking location; and
provide, to the second device, a notification associated with the parking location.

22. (canceled)
